(19) United States
(12) Patent Application Publication
(10) Pub. No.: US 2009/0084560 A1
(43) Pub. Date: Apr. 2, 2009

(54) Quick install and quick release horseshoe calk and cleat

(76) Inventors: Kaylen Spooner, Aqua Dulce, CA (US); Richard Spooner, Aqua Dulce, CA (US)

Correspondence Address: Cislo & Thomas LLP, 1333 2nd Street, Suite #500, Santa Monica, CA, 90401-4110, US

(21) Appl. No.: 11/906,523

(22) Filed: Oct. 1, 2007

(51) Int. Cl. A01L 7/04; A43C 15/00

(52) U.S. Cl. 168/31; 36/62

(57) ABSTRACT

Exemplary embodiments provided herein include a calk or cleat for a horseshoe or a human shoe including a receptacle and a stud, and methods of installing and removing the calk or cleat, or the stud of the calk or cleat. The receptacle has a can or cylindrical shape and may have an outside threaded wall capable of being threaded into a threaded hole in the horseshoe or the human shoe and an inner wall having one or more vertical keyway in communication with an annular keyway. The stud may have a top section and a barrel section with one or more keys disposed to be received in the one or more vertical keyways and the annular keyway, the one or more keys having one or more nipples to fit into one or more divots on the bottom of the annular keyway. The inventive embodiments are designed to allow for quick and easy application and removal of the calk or stud without the use of tools.

### FIELD OF THE INVENTION

This invention relates to a calk or cleat configured to achieve quick installation and quick removal. In a preferred embodiment, the invention relates to a horseshoe calk. The horseshoe calk is attached to the bottom of a horseshoe to improve traction by inserting the calk into a hole in the horseshoe. In another preferred embodiment, the invention relates to a cleat for human shoes such as golf shoes or other athletic shoes. The inventive calk or cleat does not require specific tools for insertion and removal. It is easily removed without a wrench.

### BACKGROUND OF THE INVENTION

Horses wear between four and six calks on each shoe for competitions on a grass surface. The calks must be installed on the grass and removed before the horse leaves the grass area. Currently, the calks must be screwed into a horseshoe with a wrench, and three to four full rotations are required to install or remove the calk. This has to be done while holding a horse's foot in an upright position, a difficult task that must occur in an often hectic environment where the horse is uncomfortable and excited. Accordingly, there is a need in the art for a calk designed for easy and quick insertion and removal.

In addition, many sports require an individual to wear cleats. Oftentimes, a cleat must be replaced in a sporting event before the start of a game or during a time-out. Cleat replacement must be performed quickly and preferably without the use of tools. Quick cleat insertion and removal may be necessary on the golf course as tee times are often scheduled in small windows, and golfers must continue to move efficiently while on the course. Golfers may also need to quickly remove their cleats before entering a clubhouse or other area. It is uncommon for individuals participating in sports such as golf or soccer to carry a wrench or other tool to the golf course or playing field. Therefore, there is a need for a cleat that can be installed and removed quickly and easily without tools.

### SUMMARY OF THE INVENTION

The calk or cleat of the present invention is a device designed to make installing the calks or cleats into horseshoes, golf shoes, athletic shoes, and other human shoes quick and easy. The inventive calk or cleat may use the same hole already supplied for a calk or cleat and is preferably comprised of two parts, a receptacle and a stud. The receptacle fits into the hole supplied for a calk or cleat and the stud can be installed by pushing it into the receptacle and turning. The stud may be removed by pulling and turning. No tools are necessary.

In one embodiment, the receptacle is a can or cylindrically shaped device with a outside wall that is a threaded outside wall that can be inserted into a hole supplied for a screw-in calk or cleat such as a threaded hole of a horseshoe or a threaded opening in the sole of a human shoe, and an inside wall that extends down to just above the floor of the receptacle, the inside wall having one or more vertical keyways in communication with an annular keyway. Between the threaded outside and the inside wall, there may be a pressure device such as a grommet or a spring, and one or more washers. The pressure piece may be positioned above the one or more washers, the one or more washers defining the top of the annular keyway and pushed against the floor of the inside of the receptacle. The pressure piece and the washer may be grooved to fit the one or more vertical keyways, and the one or more washers may further have a beveled ramp. One or more divots may be positioned in the bottom of the annular keyway which is also the floor of the inside of the receptacle.

In another embodiment, the receptacle is a can or cylindrically shaped device with an outside capable of being inserted into a hole supplied in a horseshoe or in the sole of a human shoe.

The stud is configured with one or more keys adapted to be received in the one or more vertical keyways and the annular keyway in the receptacle. One or more keys may be beveled to allow them to slide under a beveled washer in the receptacle. One or more nipples are positioned on the bottom of the one or more keys. In a preferred embodiment, the bottom or floor of the annular keyway, also the floor of the receptacle, is configured with a locking mechanism such as one or more divots to receive the one or more nipples to quickly and securely install the stud. The calk or cleat can be installed by positioning the receptacle into a horseshoe or the sole of a human shoe, for example, by threading, inserting the stud into the receptacle by aligning the one or more keys on the stud with the one or more vertical keyways in the receptacle, pushing the stud into the receptacle, and turning, preferably clockwise, so that the one or more keys fit into the annular keyway and the one or more nipples fit into the one or more divots, thereby locking the stud in place. In a preferred embodiment, the one or more keys slide under a washer that defines the top of the annular keyway. The pressure created by the pressure piece such as a grommet or spring in the receptacle pushes the washer down onto the one or more keys, thereby sandwiching the one or more keys between the washer and the floor or the can.

Once the stud is in, it may be removed by pulling away from the shoe and turning in the direction opposite that required for installation, for example, counterclockwise. The hole left when the stud is removed may be filled with a rubber grommet to keep debris from getting into the receptacle.

The present invention also includes methods of installing the calk or cleat and a method of removing the stud.

### BRIEF DESCRIPTION OF THE DRAWINGS

FIG. 1 is a side view of a cross-section of one embodiment of the receptacle.

FIG. 2 is a top view of one embodiment of the receptacle.

FIG. 3A is a side view of one embodiment of the stud.

FIG. 3B is an alternative side view of one embodiment of the stud where the stud is turned ninety degrees from the position in FIG. 3A.

FIG. 4 depicts the calk in use.

### DETAILED DESCRIPTION OF THE INVENTION

The detailed description set forth below in connection with the appended drawings is intended as a description of exemplary embodiments and is not intended to represent the only forms in which these embodiments may be constructed and/or utilized. The description sets forth the construction and the sequence of steps for operating the exemplary embodiments. However, it is to be understood that the same or equivalent constructions and sequences may be accomplished by different embodiments that are also intended to be encompassed within the spirit and scope of the specification.

In a preferred embodiment, the calk or cleat comes in two parts, a receptacle and a stud. The stud has a top section attached to a barrel section with one or more keys attached to the outside of the barrel section on the side of the barrel section opposite the top section. The top section may be round, oval, square, hexagonal, bell-shaped, tapered, and a combination thereof, may have further nibs positioned thereon for additional traction and grip, and may be of varying widths and lengths. The variations in the top section of the stud are designed for use in different terrains.

In one embodiment, the stud has an optional outer lip around the top section where it meets the barrel section. The one or more keys are configured to fit into the one or more vertical keyways and the annular keyway in the receptacle. The one or more keys may have one or more small nipples to assist in securing the stud in one or more divots in the bottom of the annular keyway in the receptacle. The bottom of the annular keyway is also the floor of the inside of the receptacle. The barrel section is configured to fit within the receptacle and can have a diameter of varying measurements.

The receptacle is a can or cylindrically shaped device and may have an outside wall that is a threaded outside wall. It has an inner wall with one or more vertical keyways in communication with an annular keyway. The inner wall is configured to receive the barrel section of the stud and thus may have an inner diameter of varying measurements, depending on the size of the stud. The top of the annular keyway is just high enough off of the inner floor of the receptacle to allow the one or more keys of the stud to slide under it. The keyways are constructed so as to be capable of receiving the one or more keys on the stud. The one or more keys attached to the stud are grooved to fit the one or more vertical keyways and the annular keyway in the receptacle. In one embodiment, the communication of the one or more vertical keyways and the annular keyway may include one or more washers within the receptacle, wherein the top of the annular keyway is defined by one or more washer. The washers may be made of a material selected from the group consisting of rubber, metal, steel, plastic, and combinations thereof, or any other suitable material and combinations thereof. A first washer, preferably a steel or plastic washer, defines the top of the annular keyway and optionally, a second washer, preferably a rubber washer, is positioned above the first washer so that the washers are stacked on one another. Alternatively, the receptacle includes a pressure piece positioned between the inside wall and the outside wall of the receptacle and above a first washer. The pressure piece exerts downward pressure on the one or more washers assisting in locking the stud in place. It may be a grommet or a spring. The grommet may be rubber.

The annular keyway of the receptacle is grooved to fit the key shape of the key on the stud, and may have a beveled ramp to allow the one or more keys to slide under the one or more washers into the annular keyway, thereby sandwiching the one or more keys between the one or more washers and the inner floor of the receptacle. If the annular keyway has a beveled ramp, the one or more keys of the stud will be beveled to fit into the annular keyway. The bottom of the annular keyway which is also the inner floor of the receptacle has one or more indents or divots to receive the one or more nipples on the one or more keys. Once the one or more keys are under the washers, the stud may be turned in the annular keyway until the one or more small nipples on the bottom of the one or more keys are aligned with one or more small indents or divots in the bottom of the annular keyway. The pressure created by the one or more keys under the one or more washers pushes the one or more nipples down into the one or more indents or divots which keep the stud from turning. This keeps the stud in the shoe by locking it in place. When the stud is pulled away from the shoe, the one or more nipples disengage from the one or more indents or divots. Then, the stud may be turned so that the one or more keys move in the annular keyway toward the one or more vertical keyways. The stud can be turned until the one or more keys are lined up with the one or more vertical keyways, preferably a half-turn. Once the one or more keys are in line with the one or more vertical keyways, the stud can be pulled out.

The stud and receptacle may be made of a material cast in one piece or may be manufactured as several pieces that are soldered together. Preferably, the stud and the receptacle are each cast as one piece. The stud and the outer shell of the receptacle may be made of any sturdy material; for example, materials selected from the group consisting of copper, titanium, tin, aluminum, metal, metal alloy, steel, brass, bronze, titanium alloy, duralumin, strong plastic, and combinations thereof. The receptacle may further have a pressure piece such as a grommet between the inner wall and the threaded outside wall, wherein the grommet is rubber, foam, malleable plastic, or the like. Alternatively, the pressure piece may be a spring between the inner wall and the outside wall, wherein the spring is made of a material selected from the group consisting of copper, titanium, tin, aluminum, steel, brass, bronze, titanium alloy, duralumin, strong plastic, and combinations thereof. Below the pressure piece is one or more washers. The one or more washers may be made of any sturdy material; for example, materials selected from the group consisting of copper, titanium, tin, aluminum, steel, brass, bronze, titanium alloy, duralumin, strong plastic, and combinations thereof.

The inventive cleat for a human shoe is adapted to be positioned into an opening in the sole of a shoe. In one embodiment, the cleat comprises a receptacle having a can or cylindrical shape with a threaded outside wall, capable of being screwed into the threads of threaded opening in the sole of the human shoe, and an inside wall with one or more vertical keyways in communication with an annular keyway; and a stud having a top section attached to a barrel section and one or more keys attached to the barrel portion, the one or more keys disposed to be received sequentially into the one or more vertical keyways and the annular keyway. The one or more keys may have one or more nipples or nibs that lock the stud in place by fitting into one or more indents or divots in the bottom of the annular keyway which is also the inner floor of the receptacle. In one embodiment, the annular keyway may be defined on the top by one or more washers inside the receptacle. The washers may be made of any suitable material selected from the group consisting of plastic, metal, steel, rubber, or any other suitable material, and combinations thereof. The one or more washers define the top of the annular keyway and may have a beveled ramp that facilitates the communication of the one or more vertical keyways with the annular keyway. Above the one or more washers and between the outside wall and the inside wall may be a pressure piece. The pressure piece exerts a force on the one or more washers and assists in locking the stud in place. The pressure piece may be a grommet or a spring. The bottom of the annular keyway has one or more indents or divots to receive the one or more nipples on the one or more keys. The stud of the inventive cleat may have a lip between the top section and the barrel section.

In an alternative embodiment, the receptacle of the horseshoe calk or the human shoe cleat may have a smooth outside wall that can be secured into the opening in a horseshoe or athletic shoe with an adhesive.

In yet another embodiment, the stud of the horseshoe calk or the human shoe cleat may be held in the receptacle by friction, adhesive, by a ball detente, by a spring latch, and by combinations thereof.

The present invention also includes methods of installing the calk or cleat by positioning the receptacle into a horseshoe or human shoe, for example, by threading or screwing, using an adhesive, ball detentes or spring latch; inserting the stud into the receptacle by lining up the one or more keys on the stud with the one or more vertical keyways of the receptacle; pushing the stud into the receptacle until the one or more keys in the one or more vertical keyways come into communication with the annular keyway; and turning the stud to secure the one or more divots on the one or more keys in the one or more divots in the bottom of the annular keyway. The present invention further comprises a method of removing the stud by pulling on the stud so as to dislodge the one or more nipples from the one or more divots, turning the stud so that the one or more keys of the stud move in the annular keyway until they are is lined up with the one or more vertical keyways, and pulling the stud out of the receptacle.

In yet another method, the stud may be inserted into the receptacle by using an adhesive, using a friction hold, a ball detente, or spring latch.

In an alternative method, the stud is secured into the receptacle prior to securing the receptacle in the horseshoe or the human shoe. For example, the stud may be secured in the receptacle by friction, adhesive, ball detente, spring latch, or the like. The receptacle may also be secured into a hole in the horseshoe or the human shoe by friction, adhesive, ball detente, spring latch, or the like.

FIG. 1 is a side view of a cross-section the receptacle 10 according to one embodiment of the invention. In one embodiment of the invention, the receptacle 10 is a can shape with an outer wall having a threaded outside wall 20. It has an inside wall 30 with a vertical keyway 40 in communication with an annular keyway 50. The annular keyway 50 is close to the inner floor of the receptacle 60. The vertical keyway 40 and the annular keyway 50 are in communication with each other and are constructed so as to be capable of receiving the key on the stud. The top of the annular keyway 50 is defined by a washer 70 and a grommet 80, where the grommet 80 is stacked on top of the washer 70. The grommet 80 is positioned between the outside wall 20 and the inside wall 30 and exerts force on the washer 70. The bottom of the annular keyway 50 which is also the inner floor of the receptacle 60 has one or more divots 90 configured to receive one or more nipples on the stud.

It is understood that the inside wall 30 may be of varying diameters so as to accept the stud.

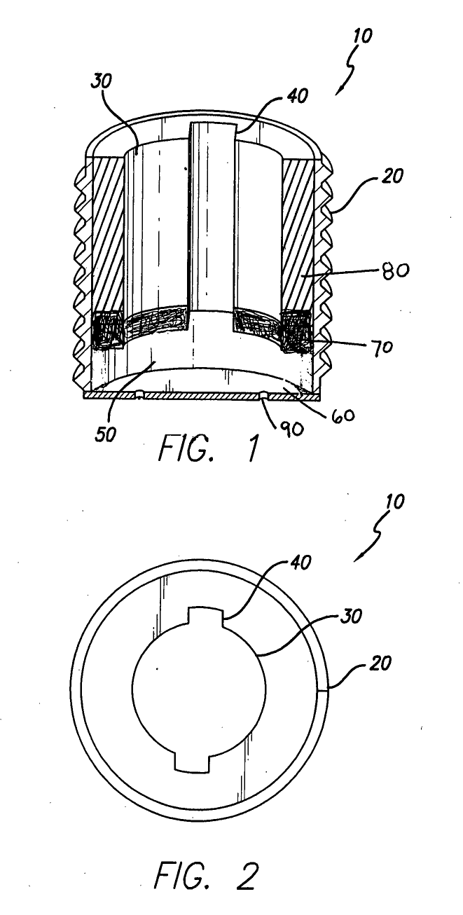

FIG. 2 is a top view of one embodiment of the receptacle 10. As shown, the top of the receptacle has a threaded outside wall 20 and a smooth inside wall 30 with a vertical keyway 40. The inside wall 30 may define varying diameters to accommodate studs of different sizes.

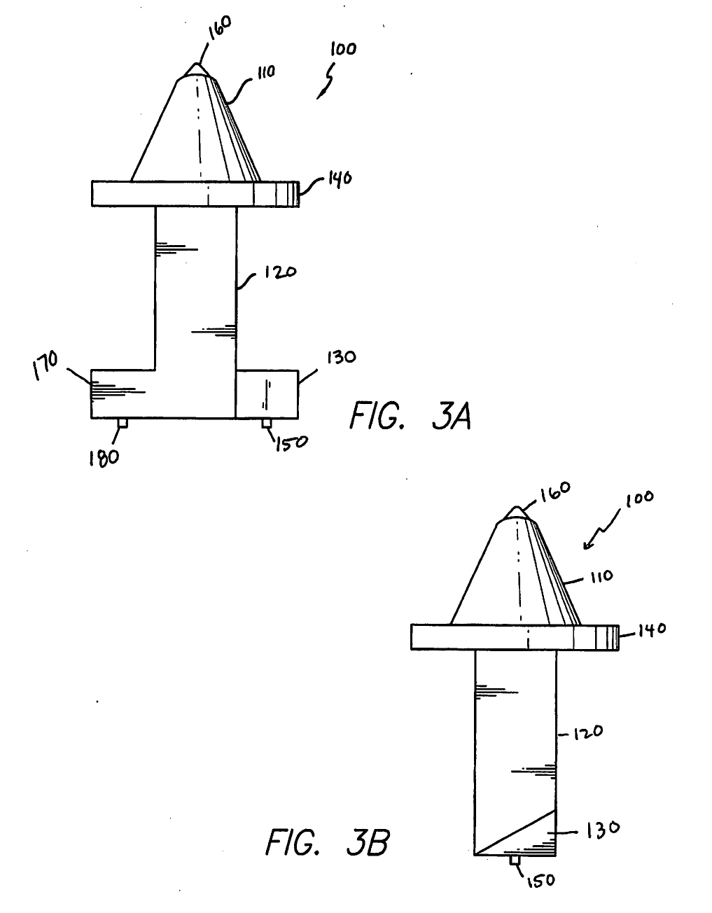

FIG. 3A is a side view of one embodiment of the stud 100. The stud 100 has a top section 110 attached to a barrel section 120 with one or more keys 130 attached to the outside of the barrel section 120 on the side of the barrel opposite the top section 110. In one embodiment, the stud has an optional outer lip 140 around the top section 110 where it meets the barrel section 120. The one or more keys 130 are configured to fit into the vertical and annular keyways in the receptacle. On the bottom of the one or more keys 130 and 170 are one or more nipples 150 and 180 to fit into one or more divots in the bottom of the annular keyway which is also the inner floor of the receptacle. The barrel section 120 may have varying diameters to be securely received in the receptacle. The top section 110 may be round, oval, square, hexagonal, bell-shaped, tapered, and a combination thereof, and may have further nibs 160 positioned thereon for additional traction and grip. The top section 110 may have varying widths and lengths. The one or more keys may be beveled to fit in a receptacle having an annular keyway defined on the top with a beveled ramp. The representative stud in FIG. 3A shows the front of one beveled key 130.

FIG. 3B is an alternative side view of one embodiment of the stud 100 where the stud 100 is pivoted ninety degrees on a vertical axis from the position in FIG. 3A. The stud 100 has a top section 110 attached to a barrel section 120. One key 130 attached to the barrel section 120 is shown. The key 130 is beveled. An optional outer lip 140 around the top section 110 where it meets the barrel section 120 is also shown. The key 130 is configured to fit into the vertical and annular keyways in the receptacle. On the bottom of the key 130 is a nipple 150 to fit into a divot in the bottom of the annular keyway which is also the inner floor of the receptacle. The barrel section 120 may have varying diameters to be securely received in the receptacle. An optional nib 160 is positioned on the top section 110 of the stud 100.

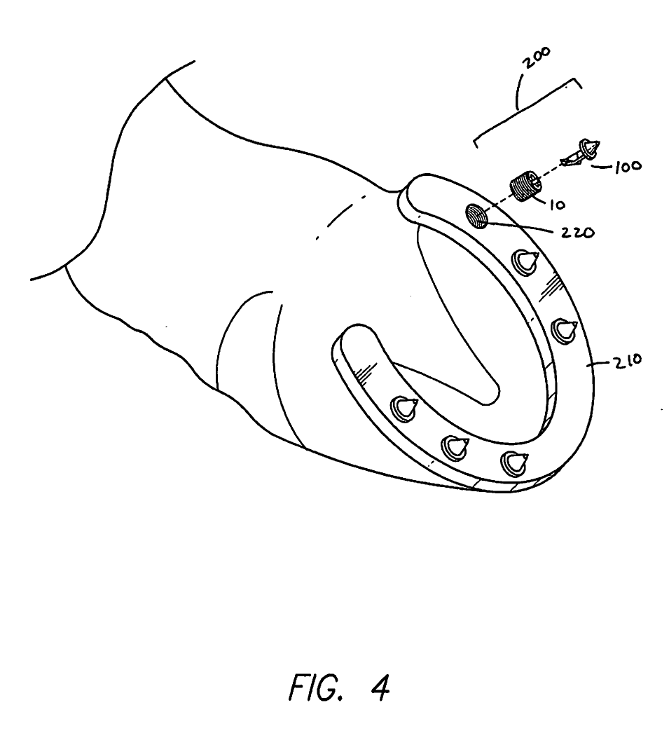

FIG. 4 depicts one embodiment of the calk 200 comprising a receptacle 10 and a stud 100 in use in a horseshoe 210. The calk 200 is placed in the horseshoe by inserting the receptacle 10 into a hole 220 in the horseshoe 210. The one or more keys of the stud 100 are lined up with the vertical keyway in the receptacle and may be inserted and removed from the receptacle as previously described.

Although the invention has been described with reference to one or more preferred embodiments, the description is not to be construed in a limiting sense. Alternative embodiments of this invention, which will be apparent to persons of ordinary skill in the art and various changes in form and detail may be made therein without departing from the spirit and scope of the invention. The invention shall be viewed as limited only by reference to the following claims.

What is claimed is:

1. A horseshoe calk adapted to be threaded into a threaded hole in a horseshoe comprising:
a receptacle having a can shape with a threaded outside wall capable of being threaded into the threaded hole of the horseshoe and an inside wall with one or more of vertical keyways in communication with an annular keyway, one or more washers defining the top of the annular keyway, a pressure piece disposed between the inside wall and the threaded outside wall and above the one or more washers, and one or more divots in the bottom of the annular keyway; and
a stud having a top section attached to a barrel section and one or more keys attached to the bottom of the barrel section, the one or more keys disposed to be received sequentially into the one or more vertical keyways and the annular keyway of the receptacle when the barrel section of the stud is inserted into the receptacle, and one or more nipples on the one or more keys adapted to fit in the one or more divots in the bottom of the annular keyway.

2. The horseshoe calk of claim 1, wherein the one or more washers are a material selected from the group consisting of copper, titanium, tin, aluminum, steel, brass, bronze, titanium alloy, duralumin, strong plastic, and combinations thereof.

3. The horseshoe calk of claim 1, wherein the top section of the stud is round, oval, square, hexagonal, bell-shaped, tapered, and combinations thereof.

4. The horseshoe calk of claim 1, wherein the pressure device is a grommet or a spring.

5. A method of installing the horseshoe calk of claim 1 comprising:
threading the receptacle having a can shape with a threaded outside wall into a threaded hole in the horseshoe,
inserting the stud into the receptacle by lining up the one or more keys of the stud with the one or more vertical keyways of the receptacle,
pushing the stud into the receptacle, and
turning the stud so that the one or more keys move into the annular keyway of the receptacle and the one or more nipples on the one or more keys fit into the one or more divots in the floor of the annular keyway.

6. A method of removing the stud from the horseshoe calk of claim 1 comprising:
pulling on the stud so as to dislodge the one or more nipples from the one or more divots,
turning the stud so that the one or more keys moves in the annular keyway until they are lined up with the one or more vertical keyways, and
pulling the stud out of the receptacle.

7. A cleat adapted to be positioned into an opening in the sole of a human shoe comprising:
a receptacle having a can shape with an outside wall capable of being positioned into the opening in the sole of the human shoe and an inside wall with one or more vertical keyways in communication with an annular keyway, one or more washers defining the top of the annular keyway, and one or more divots in the bottom of the annular keyway; and
a stud having a top section attached to a barrel section and one or more keys attached to the bottom of the barrel section, the one or more keys disposed to be received sequentially into the one or more vertical keyways and the annular keyway of the receptacle when the barrel section of the stud is inserted into the receptacle, and one or more nipples disposed on the one or more keys adapted to fit in the one or more divots in the bottom of the annular keyway.

8. The cleat of claim 7, wherein the one or more washers are a material selected from the group consisting of copper, titanium, tin, aluminum, steel, brass, bronze, titanium alloy, duralumin, strong plastic, and combinations thereof.

9. The cleat of claim 7, wherein the top section of the stud is round, oval, square, hexagonal, bell-shaped, tapered, and combinations thereof.

10. A method of installing the cleat of claim 7 into the human shoe comprising:
positioning the receptacle into the opening in sole of the human shoe,
inserting the stud into the receptacle by lining up the one or more keys of the stud with the one or more vertical keyways of the receptacle,
pushing the stud into the receptacle,
turning the stud so that the one or more keys move into the annular keyway of the receptacle, and the one or more nipples on the one or more keys fit into the one or more divots in the bottom of the annular keyway.

11. A method of removing the stud from the cleat of claim 7 comprising:
pulling on the stud so as to dislodge the one or more nipples from the one or more divots,
turning the stud so that the one or more keys move in the annular keyway until they are lined up with the one or more vertical keyways, and
pulling the stud out of the receptacle.

12. A horseshoe calk adapted to be inserted into a hole in a horseshoe comprising:
a receptacle having a can shape capable of being inserted into the hole of the horseshoe with an outside wall and an inside wall; and
a stud having a top section attached to a barrel section;
wherein the receptacle is held in the hole by friction, adhesive, ball detente, spring latch, threading, and combinations thereof; and the stud is held in the receptacle by friction, adhesive, ball detente, spring latch, locking mechanism and combinations thereof.

13. The horseshoe calk of claim 12, wherein the receptacle has one or more vertical keyway and an annular keyway, and the stud has one or more keys.

14. The horseshoe calk of claim 13, wherein the one or more keys further comprise one or more nipples and the bottom of the annular keyway has one or more divots.

15. The horseshoe calk of claim 12, wherein a pressure piece is disposed between the outside wall and the inside wall.

16. The horseshoe calk of claim 15, wherein the pressure piece is a grommet or a spring.

17. The horseshoe calk of claim 15, further comprising one or more washers below the pressure piece.

18. The horseshoe calk of claim 12, wherein the diameter of the inside of the receptacle is the same size as the diameter of the barrel section of the stud.

19. The horseshoe calk of claim 12, wherein the stud is made of a material selected from the group consisting of copper, titanium, tin, aluminum, steel, brass, bronze, titanium alloy, duralumin, strong plastic, and combinations thereof; and the receptacle is made of a material selected from the group consisting of copper, titanium, tin, aluminum, steel, brass, bronze, titanium alloy, duralumin, strong plastic, and combinations thereof.

20. The horseshoe calk of claim 12, wherein the top section of the stud is round, oval, square, hexagonal, bell-shaped, tapered, and combinations thereof.
